(19) United States
(12) Patent Application Publication
(10) Pub. No.: US 2024/0091788 A1
(43) Pub. Date: Mar. 21, 2024

(54) Device and Method for Magnetizing Glass Fragments for Safe Pick-Up

(71) Applicant: Danny Sipes, Adamsville, AL (US)

(72) Inventor: Danny Sipes, Adamsville, AL (US)

(21) Appl. No.: 18/468,797

(22) Filed: Sep. 18, 2023

Related U.S. Application Data
(60) Provisional application No. 63/408,621, filed on Sep. 21, 2022.

(51) Int. Cl. B03C 1/01; B03C 1/02; B08B 7/00; B65D 83/14; C03C 17/10

(52) U.S. Cl. CPC B03C 1/01; B03C 1/02; B08B 7/0014; B65D 83/752; C03C 17/10; B03C 2201/20; C03C 2217/261; C03C 2217/70; C03C 2218/112

(57) ABSTRACT

A metal-infused liquid glass product or coating and a method for safely picking up glass shards from a surface. The invention provides a clear metal-infused liquid stored in an aerosol can, designed for easy application on a glass surface or onto glass shards. The liquid is sprayed onto the glass surface or glass shards using a nozzle, adheres to the surface, and dries within a specific time period. Once dried, the liquid forms a transparent coating on the glass, enabling for unobstructed visibility. The liquid contains micro metallic particles that impart magnetic properties to the glass shards, making them easily attractable with a conventional magnet. The magnet can be used for attracting and picking up glass shards without using any other device. The invention simplifies the process of collecting and removing glass shards, thereby providing enhanced safety and convenience.

### CROSS-REFERENCE TO RELATED APPLICATION

The present application claims priority to, and the benefit of, U.S. Provisional Application No. 63/408,621, which was filed on Sep. 21, 2022 and is incorporated herein by reference in its entirety.

### FIELD OF THE INVENTION

The present invention generally relates to the field of glass shards pick-up device. More specifically, the present invention relates to a novel clear metal infused liquid having micro metallic particles which can be sprayed on glass shards to make them magnetic enabling a user to use a magnet to attract and pick up glass shards. The liquid can be sprayed using an aerosol can and is transparent to prevent hindering glass view. Accordingly, the present disclosure makes specific reference thereto. Nonetheless, it is to be appreciated that aspects of the present invention are also equally applicable to other like applications, devices, and methods of manufacture.

### BACKGROUND

By way of background, a glass shard is a broken piece of glass that has sharp edges. Glass shards are often left behind when windows, picture frames, or other glass objects accidentally break. When glass objects shatter, the resulting shards can be difficult to pick up. They are typically scattered on the ground and can remain hidden in various corners or crevices. They can cause serious injuries if someone accidentally steps on these shards. Moreover, glass shards can cause damage to equipment such as vacuum cleaners, lawnmowers, and other machinery if they are inadvertently picked up. The sharp edges can cause clogs, jams, or even damage to the internal components of the machinery.

Glass shards pose several challenges for cleaning up and safety. Cleaning up glass shards can be a time-consuming task. Typically, individuals use a mop or other similar device to gather the shards, but this method may not effectively remove all the small, dispersed, and fragmented pieces. Additionally, individuals are often required to bend down and kneel on the ground to pick up the shards, which can be physically demanding and uncomfortable. Even with caution and proper cleanup, glass shards can still cause lacerations. If the cuts are deep, they can be extremely damaging and may require medical attention. Individuals desire an improved way of safely picking up glass shards easily and effectively.

Therefore, there exists a long felt need in the art for an efficient and easy-to-use device and method for safely picking up glass shards. There is also a long felt need in the art for a device that enables users to easily pick up glass shards while saving considerable time and effort. Additionally, there is a long felt need in the art for a device that can make glass shards magnetic for enabling use of a magnet to pick up glass shards. Moreover, there is a long felt need in the art for a glass shards pick-up system that prevents users from kneeling and bending to pick up glass shards. Further, there is a long felt need in the art of a glass shards pick-up method that prevents users from injuries while also protecting cleaning devices from damage. Finally, there is a long felt need in the art for a means that saves considerable time and effort while improving safety when picking up broken glass pieces.

The subject matter disclosed and claimed herein, in one embodiment thereof, comprises a glass shards pick-up or collection device. The device features an aerosol canister for storing a clear metal-infused liquid, a nozzle for spraying the clear metal-infused liquid onto glass shards to make the glass shards magnetic, wherein the clear metal-infused liquid includes a plurality of micro metallic particles that impart magnetic properties to the liquid and improve the adhesion thereof to a glass surface. The liquid when sprayed onto the glass shards dries to become transparent and makes the glass shards magnetic. A magnet is used for attracting, picking up, and collecting magnetic glass shards, thereby eliminating users to touch the glass shards while not using any conventional cleaning device.

In this manner, the glass shards pick-up device of the present invention accomplishes all of the forgoing objectives and provides individuals with a clear, metal-infused liquid that can be sprayed on glass surfaces and glass fragments. The liquid is sprayed using an aerosol can and turns the glass magnetic when the liquid is sprayed on the surface and dried. The invention enables users to utilize a magnet to pick up glass shards off a floor or grass surface, thereby saving considerable time and effort.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a metal-infused liquid glass product or coating. The product or coating further comprising an aerosol canister configured for storing a clear metal-infused liquid therein, a nozzle for spraying the clear metal-infused liquid onto glass shards to make the glass shards magnetic, wherein the clear metal-infused liquid includes a plurality of micro metallic particles that impart magnetic properties to the liquid and improve the adhesion thereof to a glass surface, forming a stable and durable coating. The liquid when sprayed onto the glass shards dries to become transparent and makes the glass shards magnetic.

In yet another embodiment, the micro metallic particles are selected from the group consisting of iron particles and nickel particles.

In a further embodiment, the aerosol can includes a capacity selected from the group consisting of 4 oz., 8 oz., 12 oz., and 16 oz. cans, and is made of one or more metals, including aluminum or steel.

In a further embodiment, a handheld metal-infused liquid glass product or coating is disclosed. The further comprising an apparatus for storing a clear metal-infused liquid, a nozzle for spraying the stored clear metal-infused liquid onto at least one intact glass surface, the clear metal-infused liquid being clear and forming a mist when sprayed onto the glass surface, the sprayed liquid adhering to the glass surface and drying within a specified time period to become a transparent coating and to not obstruct the view of the glass, and the dried liquid coating imparting magnetic properties to the glass surface, thereby enabling the attraction of the glass surface by a magnet enabling a user to pick up a subsequently fragmented glass surface without touching or using any other cleaning device.

In a further embodiment, a method for safely picking up glass shards using a magnet is described. The method comprising the steps of spraying a clear metal-infused liquid onto glass shards using an aerosol can, enabling the sprayed liquid to adhere to the glass shards and dry in the presence of air for a predetermined period of time, enabling the dried liquid to become transparent and impart magnetic properties to the glass shards using micro metallic particles included in the clear metal-infused liquid, and bringing a magnet near the (i.e., proximal to) glass shards to attract the magnetic glass shards, facilitating the easy picking up of broken glasses.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a metal-infused liquid glass product or coating of the present invention in accordance with the disclosed architecture;

FIG. 2 illustrates a perspective view showing the aerosol can of FIG. 1 used for spraying the clear metal-infused liquid on an intact glass surface in accordance with the disclosed architecture;

FIG. 3 illustrates a flow diagram depicting a process of collecting and removing glass shards using a magnet in accordance with the disclosed architecture; and

FIG. 4 illustrates a perspective view showing safely collecting glass shards using a magnet in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an efficient and easy-to-use device and method for safely picking up glass shards. There is also a long felt need in the art for a device that enables users to easily pick up glass shards while saving considerable time and effort. Additionally, there is a long felt need in the art for a device that can make glass shards magnetic for enabling use of a magnet to pick up glass shards. Moreover, there is a long felt need in the art for a glass shards pick-up and collection system that prevents users from kneeling and bending to collect and pick up glass shards. Further, there is a long felt need in the art of a glass shards pick-up method that prevents users from injuries while also protecting cleaning devices from damage. Finally, there is a long felt need in the art for a means and method that saves considerable time and effort while improving safety when picking up broken glasses.

The present invention, in one exemplary embodiment, is a method for safely picking up glass shards using a magnet. The method comprising the steps of spraying a clear metal-infused liquid onto an intact glass surface or onto fragmented glass shards using an aerosol can, enabling the sprayed liquid to adhere to the glass surface or glass shards and dry in the presence of air for a predetermined period of time, enabling the dried liquid to become transparent and impart magnetic properties to the glass surface or glass shards using micro metallic particles included in the clear metal-infused liquid, and bringing a magnet near, or proximal to, the fragmented glass surface or glass shards to attract the magnetic glass pieces or glass shards, facilitating the easy picking up of broken glass.

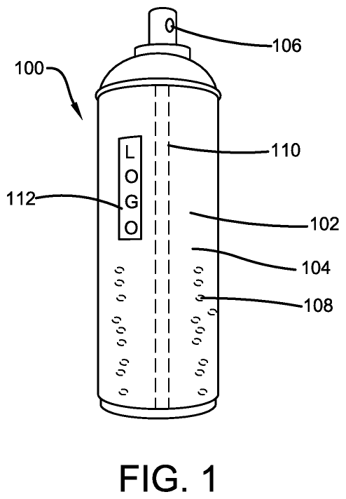

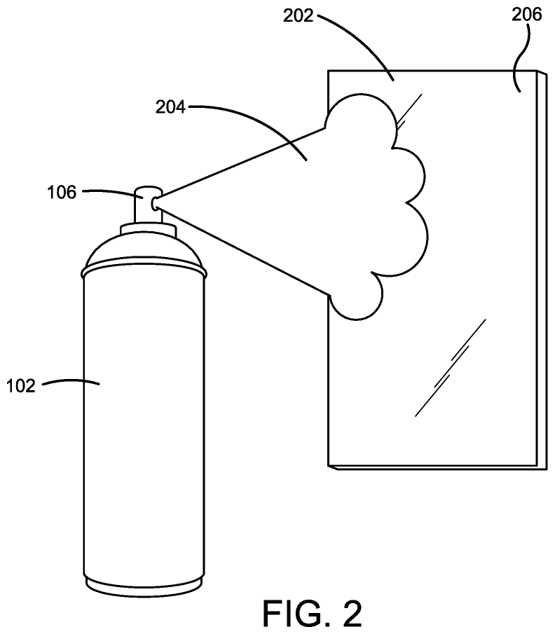

Referring initially to the drawings, FIG. 1 illustrates a perspective view of a metal-infused liquid glass product or coating of the present invention in accordance with the disclosed architecture. The metal-infused liquid glass product or coating 100 of the present invention is designed as an aerosol can 102 configured for storing a clear metal-infused liquid coating 104 therein. The aerosol can 102 includes a nozzle 106 for spraying the clear metal-infused liquid coating 104 onto a glass surface or onto glass shards as illustrated in FIG. 2 for making the glass surface, glass fragments, and glass shards magnetic. The clear metal infused liquid coating 104 includes micro metallic particles 108 which impart magnetic properties to the liquid coating 104. Micro metallic particles 108 also improve the adhesion of the liquid coating 104 to a glass surface ensuring that the liquid coating 104 forms a stable and durable coating on the glass surface or glass fragments.

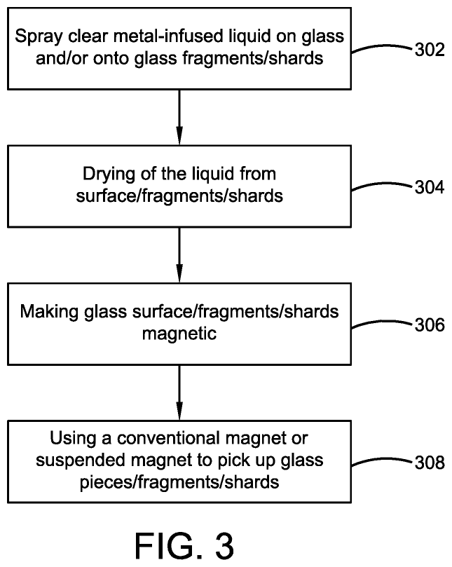

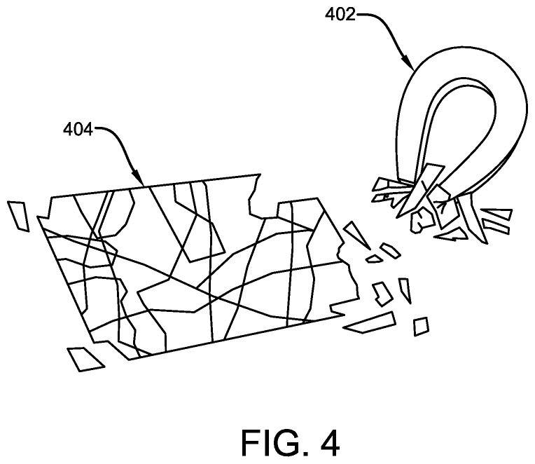

Micro metallic particles 108 can be one or more of iron particles or nickel particles. Further, the liquid coating 104 is clear and transparent, thereby not hindering or obstructing visibility of the glass surface on which the liquid coating 104 is sprayed. The liquid coating 104 adheres to a glass surface and creates a magnetic effect. Once the liquid coating 104 dries on the glass surface, a magnet can be subsequently brought close to the fragmented glass surface as described in FIGS. 3 and 4, and the magnetic force of the magnet can attract and hold the glass fragments and glass shards, making it easy to collect the fragments and shards easily.

The aerosol can 102 can come in different capacities, preferably including 4 oz., 8 oz., 12 oz., and 16 oz. cans. Further, the aerosol can 102 is made from one or more metal, most commonly aluminum or steel. The aluminum can 102 is designed as lightweight, corrosion-resistant, and recyclable. For effective spraying of the liquid coating 104, the metal-infused liquid aerosol can product or coating 100 includes a valve system 110. The valve system 110 is designed to be opened when the nozzle 106 is pressed by a user for spraying the liquid coating 104. The aerosol can 102 can be designed to have any spray pattern from a wide cone, narrow stream, or mist for effective spraying of the liquid. The aerosol can 102 can have a logo 112 providing product name, ingredients, and more for marketing purposes.

FIG. 2 illustrates a perspective view showing the aerosol can of FIG. 1 used for spraying the clear metal-infused liquid on a glass surface in accordance with the disclosed architecture. The metal-infused liquid glass product or coating 100 is handheld and can be used for spraying the stored clear metal-infused liquid coating 104 on a glass surface 202. The liquid coating 104 is clear and adheres on the glass surface 202 in the form of mist 204. After a few seconds, preferably 5-10 seconds, the sprayed liquid coating 206 on the glass surface 202 dries in the ambient air and becomes transparent, therefore, the liquid coating 206 does not obstruct view of the glass surface 202. As described earlier, after drying, the liquid coating 104 makes the glass surface 202 magnetic and thus allows a user to use a magnet to attract the glass surface 202, and subsequent glass fragments, easily.

FIG. 3 illustrates a flow diagram depicting a process of collecting and removing glass fragments/shards using a magnet in accordance with the disclosed architecture. Initially, the clear metal-infused liquid is sprayed on a glass surface and/or onto glass fragments/shards using the aerosol can (Step 302). The liquid can be sprayed by pressing the nozzle of the aerosol can easily by individuals of all ages and gender. Then, the liquid adheres onto the glass surface/fragments/shards and dries in presence of ambient air after a predetermined period of time (Step 304). Thereafter, upon drying, the liquid becomes transparent and makes the glass surface/fragments/shards magnetic using the micro metallic particles included in the clear metal-infused liquid (Step 306). Finally, a conventional magnet, or suspended magnet, is used and is brought near, or proximal to, the glass pieces/fragments/shards, enabling the magnet to attract the magnetic glass pieces/fragments/shards for easy collecting of broken glasses (Step 308).

It should be noted that in an alternative embodiment, the magnetic effect of the liquid coating 104 on the glass shards is automatically removed by evaporation of the liquid mist. The magnetic effect of the liquid coating 104 can be automatically removed after a threshold time which can range from 10 minutes to 20 minutes and can depend on the type of micro metallic particles used in the clear metal-infused liquid.

FIG. 4 illustrates a perspective view showing the safe collection of glass fragments/shards using a magnet in accordance with the disclosed architecture. As illustrated, a magnet 402 can be brought near glass fragments/shards 404 which are magnetized using the clear metal-infused liquid coating 104 as described in FIGS. 2 and 3. The magnet 402 can be commercially available with the glass magnet product or coating 100 or can be any conventional magnet. The glass fragments/shards 404 are easily attracted to the magnet 402 and the magnet 402 holds the glass fragments/shards 404, making it easy for a user to collect the glass fragments/shards 404 easily and without any injury.

It should be understood that the metal-infused liquid glass product or coating 100 simplifies the process of glass shard collection and removal from grass, floors, and other areas without using any cleaning device such as a vacuum cleaner and without causing any injury to a user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “metal-infused liquid glass product or coating”, “metal-infused liquid aerosol can product”, “glass magnet”, and “device” are interchangeable and refer to the metal-infused liquid glass product or coating 100 of the present invention.

Notwithstanding the forgoing, the metal-infused liquid glass product or coating 100 of the present invention can be of any suitable size and configuration as is known in the art without affecting the overall concept of the invention, provided that it accomplishes the above stated objectives. One of ordinary skill in the art will appreciate that the metal-infused liquid glass product or coating 100 as shown in the FIGS. are for illustrative purposes only, and that many other sizes and shapes of the metal-infused liquid glass product or coating 100 are well within the scope of the present disclosure. Although the dimensions of the metal-infused liquid glass product 100 are important design parameters for user convenience, the metal-infused liquid glass product 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A metal-infused liquid glass coating product comprising:
a metal-infused liquid glass coating having micro metallic particles for imparting magnetic properties to said liquid glass coating and for imparting adhesion to a glass surface;
a liquid glass coating product having an aerosol can configured for storing said liquid glass coating;
wherein said aerosol can having a nozzle for spraying said liquid glass coating; and
further wherein said liquid glass coating sprayed onto said glass surface for subsequent attraction to a magnet moved proximal to said glass surface.

2. The metal-infused liquid glass coating product of claim 1, wherein said glass surface is an intact glass surface.

3. The metal-infused liquid glass coating product of claim 1, wherein said glass surface is a plurality of glass fragments.

4. The metal-infused liquid glass coating product of claim 1, wherein said glass surface is a plurality of glass shards.

5. The metal-infused liquid glass coating product of claim 1, wherein said metal-infused liquid glass product coating is an aerosol.

6. The metal-infused liquid glass coating product of claim 1, wherein said micro metallic particles are selected from a group consisting of iron particles and nickel particles.

7. The metal-infused liquid glass coating product of claim 1, wherein said metal-infused liquid glass product coating is clear.

8. The metal-infused liquid glass coating product of claim 1, wherein said metal-infused liquid glass product coating is transparent.

9. The metal-infused liquid glass coating product of claim 1, wherein said aerosol can is selected from a capacity consisting of a 4 ounce can, an 8 ounce can, a 12 ounce can, and a 16 ounce can.

10. The metal-infused liquid glass coating product of claim 9, wherein said aerosol can is handheld.

11. A metal-infused liquid glass coating product comprising:
a metal-infused liquid glass coating having micro metallic particles for imparting magnetic properties to said liquid glass coating and for imparting adhesion to a glass surface;
a liquid glass coating product having an aerosol can configured for storing said liquid glass coating;
wherein said aerosol can having a nozzle for spraying said liquid glass coating;
wherein said liquid glass coating sprayed onto said glass surface for subsequent attraction to a magnet moved proximal to said glass surface;
wherein said metal-infused liquid glass product coating is an aerosol; and
further wherein said micro metallic particles are selected from a group consisting of iron particles and nickel particles.

12. The metal-infused liquid glass coating product of claim 11, wherein said glass surface is an intact glass surface.

13. The metal-infused liquid glass coating product of claim 11, wherein said glass surface is a plurality of glass fragments.

14. The metal-infused liquid glass coating product of claim 11, wherein said glass surface is a plurality of glass shards.

15. The metal-infused liquid glass coating product of claim 11, wherein said metal-infused liquid glass product coating is clear.

16. The metal-infused liquid glass coating product of claim 11, wherein said metal-infused liquid glass product coating is transparent.

17. The metal-infused liquid glass coating product of claim 11, wherein said aerosol can is handheld.

18. A method of collecting pieces of a glass surface, the method comprising the steps of:
providing a metal-infused liquid glass coating having micro metallic particles for imparting magnetic properties to said liquid glass coating and for imparting adhesion to a glass surface;
storing said liquid glass coating in an aerosol can, wherein said aerosol can having a nozzle for spraying said liquid glass coating;
spraying said liquid glass coating onto said glass surface;
drying said liquid glass coating onto said glass surface for subsequent attraction to a magnet; and
moving the magnet proximal to the pieces of said glass surface.

19. The method of magnetizing a glass surface of claim 18, wherein said micro metallic particles are selected from a group consisting of iron particles and nickel particles.

20. The method of magnetizing a glass surface of claim 19 wherein said glass surface is selected from a group consisting of an intact glass surface, a plurality of glass fragments, and a plurality of glass shards.
